(19) United States
(12) Patent Application Publication
(10) Pub. No.: US 2013/0142587 A1
(43) Pub. Date: Jun. 6, 2013

(54) COUPLING DEVICE

(71) Applicant: PLANEX DESIGN PTY LTD, Hallam (AU)

(72) Inventors: Jean-Pierre Luc Jardel, Hallam (AU); Leo Peter Ryner, Hallam (AU)

(73) Assignee: PLANEX DESIGN PTY LTD, Hallam (AU)

(21) Appl. No.: 13/690,300

(22) Filed: Nov. 30, 2012

(30) Foreign Application Priority Data
Dec. 2, 2011 (AU) 2011905022

(51) Int. Cl. F16B 33/00

(52) U.S. Cl. CPC F16B 33/00
USPC 411/337

(57) ABSTRACT

A fastener element has an equal number of integrally-formed, female clamps and male clamps extending from an end face. Each female clamp is substantially “U-shaped” in side profile and is adapted to receive a male clamp.

### FIELD OF THE INVENTION

The present invention relates to couplings which are used for mechanical joining or fixing of two or more objects together and disassembly of the joined objects. In particular the present invention relates to a releasable coupling device for releasably joining or fixing two or more elements or objects together substantially without the need for tools.

### BACKGROUND OF THE INVENTION

Fasteners such as nuts, bolts, screws and rivets are known for fastening objects together. These types of fasteners usually require tools such as hammers, screw drivers, pliers or spanners, and special applicators for fastening objects together.

While above conventional fasteners are often satisfactory in fastening objects together, a practical drawback is that once objects are fastened together, it is problematic to reverse the fastening, and particularly without a great deal of labor and tools. In the case of modular structures requiring assembly of multiple components such as furniture for example, the use of conventional fasteners for joining individual components often proves to be counterproductive because there is frequently cause to disassemble and reassembling of components during assembly of such furniture, and in some instances a wide degree of design freedom exists to create different furniture designs.

Fasteners which result in components being permanently or fixedly joined together restrict the ability to easily alter or assemble a structure such as built furniture for example without substantially damaging the strength or appearance of the structure. Often, the same tools used to fasten objects together using conventional fasteners will be required to ply apart fastened objects or components. This can cause considerable problems for customers and installers working in a constantly changing environment such as is often experienced for example at work stations and other office layout conditions.

In furniture production, for example, in particular office furniture production, individual components are generally combined in a multitude of arrangements to give a corresponding multitude of different overall shapes and appearances. Because of the vast multitude of different designs available for structural assemblies such as furniture for example, it is desirable to provide customers with an easy means of assembling or disassembling components to enable efficient and practical redesign of a structure such as, for example, furniture or office work station.

Current methods of joining components or panels of assemblies generally include preformed openings in panels and a plurality of dowel plugs which are insertable within the openings and protrude to an extent to allow mounting of a second panel opening. One particular drawback with such system however is that the plugs of dowel can be difficult to remove from an opening once inserted, and therefore if at least partial disassembly is required this can be time consuming and labor intensive to extract.

Hence there is a need for a coupling means to allow for the ready assembly and disassembly of components of an assembly to enable variation in the appearance and structure of the furniture without damaging the integrity, structure, secure formation or overall appearance of the assembly such as, for example, furniture. In addition, there is a need for the coupling to have an aesthetically pleasing appearance.

### SUMMARY OF THE INVENTION

The present invention is directed to a releasable coupling device for releasably fastening two or more objects or elements having openings therein, the coupling device comprising:
a first body, adapted for releasable coupling to a second body, the first body having a first surface and a second surface separated by an edge;
a clamping lip extending about the edge and protruding from the second surface;
a locking structure mounted to a portion of the second surface, the locking structure adapted for releaseable engagement with a complementary structure on the second body in a clamping condition;
wherein the locking structure is adapted to be received within an opening or aligned openings in the two or more objects or elements, and whereby in a clamping condition the clamping lip engages a surface of one element or object about the opening to allow coupling of the at least one or more objects or elements.

In a further aspect of the present invention, there is disclosed a system for releasably coupling two or more objects or elements with each object or element having assembly openings, the system comprising:
a first body having a first surface and a second opposite surface separated by an edge, and a clamping lip extending about the edge and protruding from the second surface; and
a second body having a first surface and a second opposite surface separated by an edge, and a clamping lip extending about the edge and protruding from the second surface;
wherein the first and second body having complementary mating structures mounted to surface portions of the second surface, the complementary mating structures being insertable through aligned openings in the two or more objects or elements, and whereby the first and second body are moveable relative to each other between a releaseable condition and a clamping condition;
whereby in a clamping condition, the clamping lip of each of the first and second body engages a surface of the elements or objects about the respective openings to assemble the one or more objects or elements together.

In accordance with a further related aspect of the invention there is provided a releasable coupling device for releasably coupling two or more objects or elements with each object or element having assembly openings, the device comprising:
a substantially symmetric housing formed by releasably joining a first body and a second body, each body having a first and second surface separated by an edge, and a clamping lip extending about the edge and protruding from the second surface,
the first and second body each including a mounting structure extending from a portion of the respective second surface;
whereby the mounting structures provide complementary mating components such that the coupling device can slidably move between a clamping condition in which the structures are releasably locked and clamping lips of the first and second body frictionally engage opposite surfaces of the two or more objects or elements about the respective openings thereby coupling the two objects or elements together, and a releasable condition in which the two objects or elements can be disassembled.

The present invention provides an advance in assembly efficiency over the prior art devices because it provides a practical means of coupling at least two objects or elements together substantially without the need for conventional fastening tool, while also allowing ready release of the objects or elements from a coupling condition by sliding movement. Hence an assembly may be easily disassembled and reconfigured.

In one embodiment, the complementary mating structures can include a pair of first clamp members and a pair of second clamp members, whereby the first and second pairs of clamp members are mounted alternately on orprotruding from the second face.

Each of the pair of first clamp members can comprise:
a base portion which extends substantially parallel to the surface of the second face;
a longitudinal portion which extends from the base; and
an arm portion which extends from the longitudinal portion substantially parallel to the base;
so that the base portion, the longitudinal portion and the arm portion define a void;

Each of the pair of second clamp members can comprise:
a longitudinal portion which extends at a substantially right angle from the second face; and
an arm portion which:
   extends from the longitudinal portion substantially parallel to the base of the first clamp; and
   is dimensioned to be received within the void formed by the first pair of clamp members.

The complementary mating interlocking structures can include at least one stop surface for limiting sliding movement of one body relative to a second body.

In a related aspect, the present invention provides a fastener element comprising:
a body having a first face and a second face;
an equal number of a first clamp and a second clamp placed alternately and extending from the second face:
   each first clamp comprising:
      a base portion which extends substantially parallel to the surface of the second face;
      a longitudinal portion which extends from the base; and
      an arm portion which extends from the longitudinal portion substantially parallel to the base;
   so that the base portion, the longitudinal portion and the arm portion define a void;
   each second clamp comprising:
      a longitudinal portion which extends at a substantially right angle from the second face; and
      an arm portion which:
         extends from the longitudinal portion substantially parallel to the base of the first clamp; and is dimensioned to be received within the void.

In a further embodiment, the pair of first clamp members can be female clamp members, and the second pair of clamp members can be male clamp members whereby the male clamp members of the body are adapted for releasable sliding engagement with a pair of female clamp members on a second body, and whereby the pair of female clamp members of the body are adapted for releasable sliding engagement with a pair of male clamp members on the second body.

In yet a further related aspect, the present invention provides a fastener element comprising:
a body having a longitudinal axis and comprising a first face and a second face at opposite ends of the longitudinal axis;
an equal number of female clamps and male clamps placed alternately and extending from the second face:
   each female clamp comprising:
      a base which extends substantially transversely to the longitudinal axis;
      a longitudinal portion which extends from the base substantially parallel to the longitudinal axis; and
      a transverse portion which extends from the longitudinal portion substantially parallel to, and in the same direction as, the base;
   so that the base, the longitudinal portion and the arm portion define a void; each male clamp comprising:
      a longitudinal portion which extends at a substantially right angle from the second face; and
      a transverse portion which:
         extends from the longitudinal portion substantially parallel to and in the opposite direction from the bases of the female clamps; and
         is dimensioned to be received within the void.

It is preferred that the female clamp and the male clamp are integrally formed with the body.

It is preferred that the base of the female clamp extends in the direction from the longitudinal axis of the fastener element towards the transverse portion of the female clamp. Alternatively, it is preferred that the base of the female clamp extends in the direction from the transverse portion of the female clamp towards the longitudinal axis of the fastener element.

It is preferred that the base of each female clamp is a portion of the second face.

It is preferred that the fastener element further comprises a male clamp landing area between each female clamp and each male clamp.

It is preferred that each sequential male clamp, male clamp landing area, and female clamp are relatively placed in the clockwise direction when the fastener element is viewed in the direction of the longitudinal axis, looking towards the second face.

It is preferred that each male clamp landing area further comprises a face which is adapted to limit rotational movement of a female clamp about the longitudinal axis.

It is preferred that there are at least two male clamps and the same number of female clamps. It is particularly preferred that there are two male clamps and two female clamps.

It is preferred that the body of the fastener element, when viewed in plan view, extends in the transverse direction beyond the male clamps, male clamp landing areas, and female clamps. It is particularly preferred that the periphery of the body of the fastener element is circular in plan view.

It is preferred that the first face comprises means for rotationally driving the fastener element.

It is preferred that the means for rotationally driving the fastener element comprises a coupling for receipt of a driving tool. It is particularly preferred that the coupling is one of:
a slot for the receipt of a screwdriver or the like;
a pan head; and
a hex head.

Alternatively it is preferred that the means for rotationally driving the fastener element is a manually-engageable profile. It is particularly preferred that manually-engageable profile is a thumb wheel or other non-tool driven element.

### BRIEF DESCRIPTION OF THE DRAWINGS

For a better understanding of the invention, and to show how it may be carried into effect, embodiments of it are shown, by way of non-limiting example only, in the accompanying drawings. In the drawings:

FIG. 1 is a perspective view of one side of fastener element according to a preferred embodiment of the invention;

FIG. 2 is a perspective view of the fastener element of FIG. 1, from a different viewpoint;

FIG. 3 is a plan view of the opposite side of the fastener element of the embodiment of FIG. 1;

FIG. 4 is view from underneath of the embodiment of FIG. 1;

FIG. 5 is a side view of the fastener of FIG. 1;

FIG. 6 is another side view, displaced by 90°, of the fastener of FIG. 1;

FIG. 7 is a cross-sectional view (partly in elevation), on the line A-A of FIG. 3;

FIG. 8 is a cross-sectional view (partly in elevation); on the line B-B of FIG. 3;

FIG. 9 is a cross-sectional view (partly in elevation), on the line C-C of FIG. 3; and

FIGS. 10, 11 and 12 are cross-sectional views illustrating aspects of the use of the embodiment of FIG. 1.

### DESCRIPTION OF PREFERRED EMBODIMENTS OF THE INVENTION

Referring to the figures there is shown a coupling device for releasably fastening at least two objects or elements such as panels of an assembly for example, a furniture assembly. The device comprises at least in part of a first body having a first surface and a second surface separated by a edge, and a clamping lip extending about the edge and protruding from the second surface so as to engage with the object or element. The first body further includes a releaseable locking structure mounted to a portion of the second surface, the locking structure being adapted for releasable sliding engagement with a complementary locking structure of a second body.

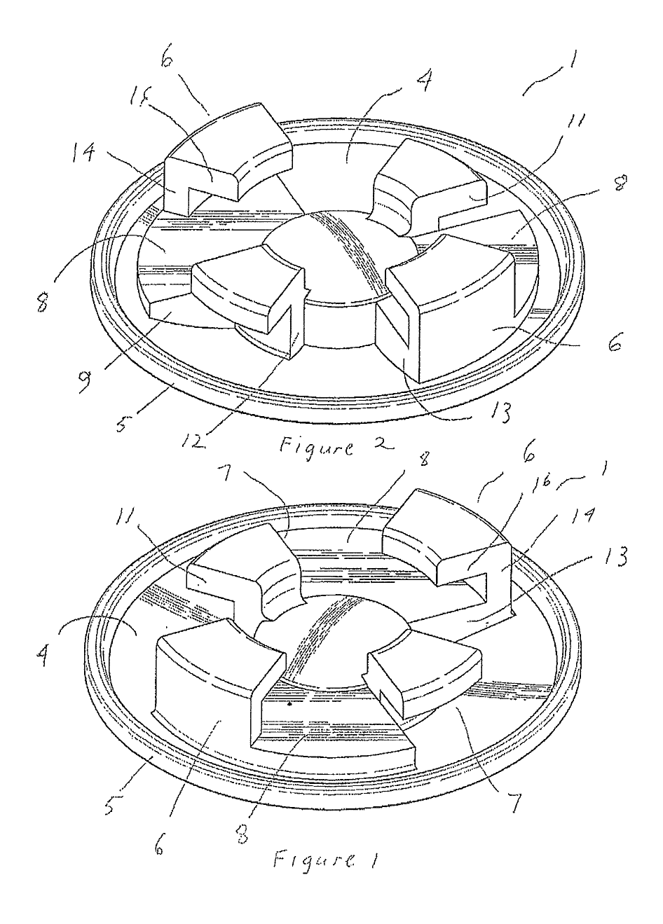

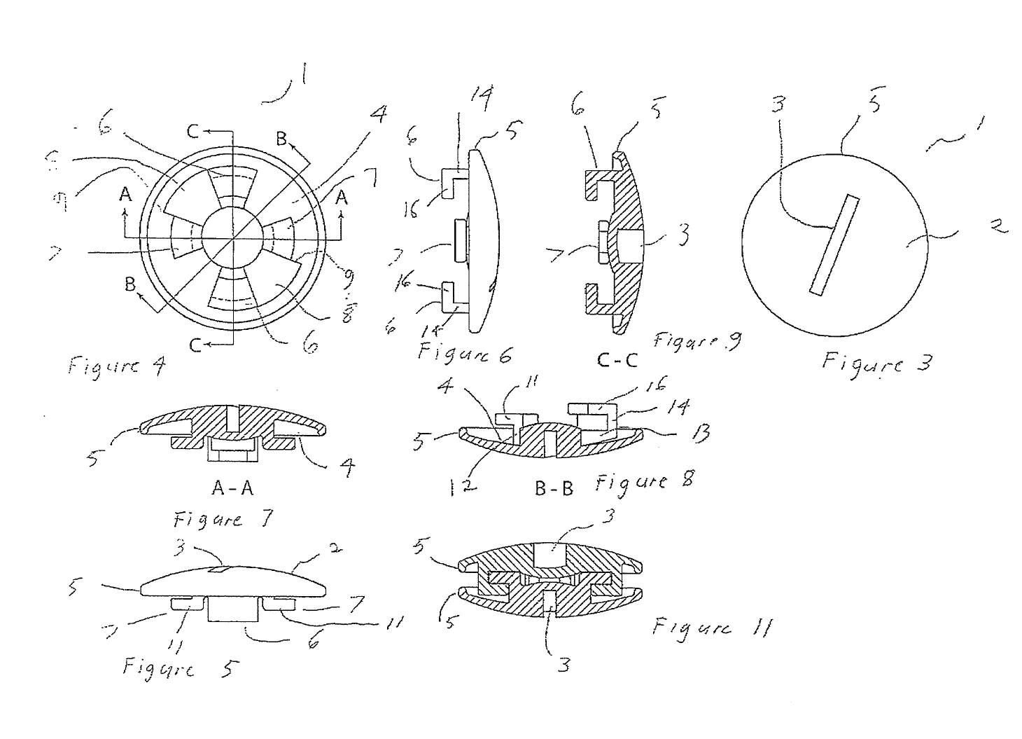

As best seen in FIG. 12, the clamping lip of the first body engages a surface portion of one element or object in a clamping condition about an opening in the object or element to allow coupling of at least one or more objects or elements in an assembly. The complementary locking structures of the first and second body (refer FIGS. 1, 2), can be slidably removed from an engaged condition to allow easy release of elements. To assist clamping or coupling of two or more objects or elements such as panels, the second face of the body is concave or at least partially concave where the releaseable locking structure is located.

As shown in the drawings, the fastener element 1 is symmetrical about a longitudinal axis and has a first face 2 and a second opposite face 4.

The second face 4 of the body has a releaseable locking structure, engagable with complementary locking structure of a second body, the locking structure being integrally formed with the second face. The locking structure comprises projections extending from the second face 4, extending in a longitudinal direction. Those projections include two diametrically-opposite female clamps 6, two diametrically-opposite male clamp landing areas 8, and two diametrically-opposite male clamps 7. Although the figures show two of each of the female clamps 6, the male clamps 7, and the male clamp landing areas 8, it will be appreciated from the following description that the fastener element is not limited to having two of each of these projections. It is however necessary that the number of each of these projections be the same. Considering the orientation of the fastener element as is shown in FIGS. 1 and 4, the male clamp landing areas 8 are displaced clockwise relative to the male clamps 7. Similarly, the female clamps 6 are displaced clockwise relative to the male clamp landing areas 8. As will also be appreciated from the following description of the operation of the fastener element 1, this clockwise relative positioning of the male clamps 7, the male clamp landing areas 8 and of the female clamps 6 result in the fastener element 1 operating as a “right-handed” fastener. The reversal of this relative rotational positioning would result in a “left-handed” fastener.

Each female clamp 6 is substantially “U-shaped” in side profile, having a radially-inwardly extending base 13 which is contiguous with the inner face 4, a longitudinally extending portion 14 which extends away from the face 4 and a radially-inwardly extending portion 16 which is contiguous with, and which extends away from, the longitudinally-extending portion 14. Both the inner and outer faces of the longitudinally extending portion 14 substantially conform to arcs of circles.

Each male clamp 7 is substantially “L-shaped” in side profile, having a longitudinally-extending portion 12 which extends away from the inner face 4 of the element 1 and a radially-outwardly extending portion 11 which is contiguous with, and which extends away from, the longitudinally extending portion 11. The periphery of the radially-outwardly extending portion 11 substantially conforms to an arc of a circle.

The radially-outwardly extending portion 11 of each male clamp 7 has a profile which allows it to be received within the inner part of the U-shaped profile of a female clamp 6.

The periphery 5 of the fastener element 1 extends radially beyond the outer faces of the longitudinally extending portions 14.

A male clamp landing area 8 is contiguous with, and extends anti-clockwise away from, the radially-inwardly extending base 13 of each female clamp 6. Each male clamp landing area 8 extends anti-clockwise to the closest male clamp 6, where it terminates with a substantially planar female clamp twist limiting face 9.

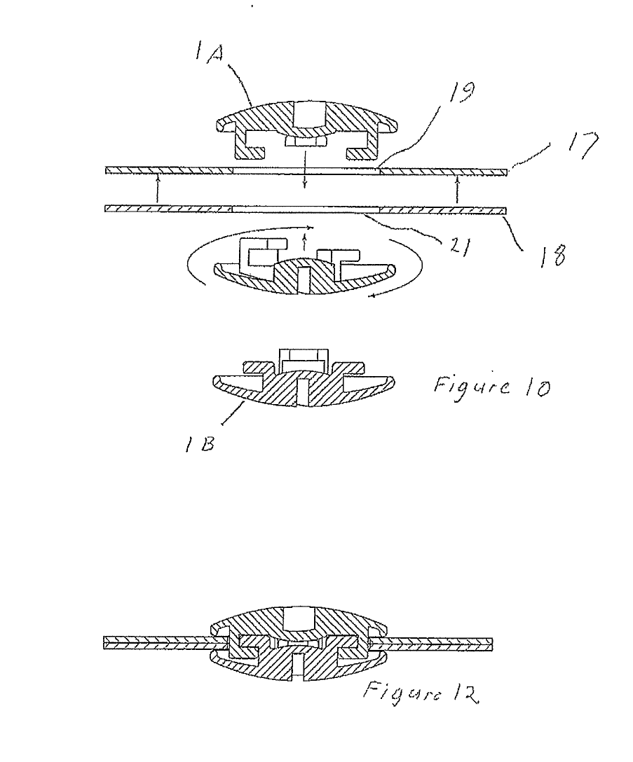

The first face 2 has a slot 3 extending along a portion of a diameter of the fastener element for receipt of a driving tool such as a screwdriver. Operation of a fastener element 1 is illustrated in FIGS. 10, 11 and 12, which illustrate the use of two substantially identical fastener elements 1A and 1B according to embodiments of the present invention to join two objects 17 and 18.

The two objects 17 and 18 each have apertures 19 and 21 extending through them. The objects 17 and 18 are placed together with the apertures 19 and 21 in alignment. A fastener element 1A is placed through the aligned apertures 19 and 21 and a fastener element 1B is pushed into contact with the fastener element 1A so that the male clamps 7 on each fastener element are in alignment with the male clamp landing areas 8 of the other fastener element. The fastener elements 1A and 1B are then rotated relatively clockwise, forcing the radially extending part 11 of each male clamp 6 into the void which is defined by the radially-inwardly extending base 13, the longitudinally-extending part 14 and the radially-inwardly extending upper part 16 of a female clamp 6. Resilience of the female clamp 6 and of the male clamp 7 operates to keep the objects 17 and 18 firmly in contact.

It will be appreciated that the lengths of the longitudinally extending parts 12 and 14 of the male clamp 7 and of the female clamp 6 must be chosen so that there is clearance between the fastener elements 1A and 1B which is sufficient to receive the two objects 17 and 18 between them, but which is not so large as to prevent the resilient clamping together of the two objects.

The device of the present invention can be manufactured from plastic material using known methods including casting, moulding and machining. Preferred materials for the fastener element 1 include plastics, aluminium, brass and other materials which can be cast, moulded or machined.

A clear advantage of the instant invention is that only one mold is required to make a pair of bodies. The pair of bodies in a coupling assembly are substantially identical and are capable of releasable interlocking to clamp two panels together while allowing easy removal from a clamping condition by slidable movement of one body relative to the second.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

A reference to any prior art in this specification is not, and should not be taken as, an acknowledgment or any form of suggestion that the referenced prior art forms part of the common general knowledge in Australia.

Throughout this specification, the words “comprise”, “comprised”, “comprising” and “comprises” are to be taken to specify the presence of stated features, integers, steps or components but does not preclude the presence or addition of one or more other features, integers, steps, components or groups thereof.

In the claims, each dependent claim is to be read as being within the scope of its parent claim or claims, in the sense that a dependent claim is not to be interpreted as infringed unless its parent claims are also infringed.

The claims defining the invention are as follows:

1. A releasable coupling device for releasably fastening two or more objects or elements having openings therein, the coupling device comprising:
a first body, adapted for releasable coupling to a second body, the first body having a first surface and a second surface separated by an edge;
a clamping lip extending about the edge and protruding from the second surface;
a locking structure mounted to a portion of the second surface, the locking structure adapted for releaseable engagement with a complementary structure on the second body in a clamping condition;
wherein the locking structure is adapted to be received within an opening or aligned openings in the two or more objects or elements, and whereby in a clamping condition the clamping lip engages a surface of one element or object about the opening to allow coupling of the at least one or more objects or elements.

2. A system for releasably coupling two or more objects or elements wherein each object or element having assembly openings, the system comprising:
a first body having a first surface and a second opposite surface separated by an edge, and a clamping lip extending about the edge and protruding from the second surface; and
a second body having a first surface and a second opposite surface separated by an edge, and a clamping lip extending about the edge and protruding from the second surface;
wherein the first and second body having complementary mating structures mounted to surface portions of the second surface, the complementary mating structures being insertable through aligned openings in the two or more objects or elements, and whereby the first and second body are moveable relative to each other between a releaseable condition and a clamping condition;
whereby in a clamping condition, the clamping lip of each of the first and second body engages a surface of the elements or objects about the respective openings to assemble the one or more objects or elements together.

3. A releasable coupling device for releasably coupling two or more objects or elements wherein each object or element having assembly openings, the device comprising:
a substantially symmetric housing formed by releasably joining a first body and a second body, each body having a first and second surface separated by an edge, and a clamping lip extending about the edge and protruding from the second surface,
the first and second body each including a mounting structure extending from a portion of the respective second surface;
whereby the mounting structures provide complementary mating components such that the coupling device can slidably move between a clamping condition in which the structures are releasably locked and clamping lips of the first and second body frictionally engage opposite surfaces of the two or more objects or elements about the respective openings thereby coupling the two objects or elements together, and a releasable condition in which the two objects or elements can be disassembled.

4. A releasable coupling device for releasably coupling two or more objects or elements according to claim 3 wherein the complementary mating structures comprises a pair of first clamp members and a pair of second clamp members, whereby the first and second pairs of clamp members are mounted alternately on and extending from the second face.

5. A releasable coupling device for releasably coupling two or more objects or elements according to claim 4 wherein each of the pair of first clamp members can comprise:
a base portion which extends substantially parallel to the surface of the second face;
a longitudinal portion which extends from the base; and
an arm portion which extends from the longitudinal portion substantially parallel to the base;
so that the base portion, the longitudinal portion and the arm portion define a void;

6. A releasable coupling device for releasably coupling two or more objects or elements according to claim 4 wherein each of the pair of second clamp members can comprise:
a longitudinal portion which extends at a substantially right angle from the second face; and
an arm portion which:
extends from the longitudinal portion substantially parallel to the base of the first clamp; and
is dimensioned to be received within the void formed by the first pair of clamp members.

7. A releasable coupling device for releasably coupling two or more objects or elements according to claim 3 wherein the complementary mating interlocking structures comprise at least one stop surface for limiting sliding movement of one body relative to a second body.

8. A fastener element comprising:
a body having a first face and a second face;
an equal number of a first clamp and a second clamp placed alternately and extending from the second face:
each first clamp comprising:
a base portion which extends substantially parallel to the surface of the second face;
a longitudinal portion which extends from the base; and
an arm portion which extends from the longitudinal portion substantially parallel to the base;
so that the base portion, the longitudinal portion and the arm portion define a void;
each second clamp comprising:
a longitudinal portion which extends at a substantially right angle from the second face; and
an arm portion which:
extends from the longitudinal portion substantially parallel to the base of the first clamp; and
is dimensioned to be received within the void.

9. A releasable coupling device for releasably coupling two or more objects or elements according to claim 8 wherein the pair of first clamp members can be female clamp members, and the second pair of clamp members can be male clamp members whereby the male clamp members of the body are adapted for releasable sliding engagement with a pair of female clamp members on a second body, and whereby the pair of female clamp members of the body are adapted for releasable sliding engagement with a pair of male clamp members on the second body.

10. A fastener element comprising:
a body having a longitudinal axis and comprising a first face and a second face at opposite ends of the longitudinal axis;
an equal number of female clamps and male clamps placed alternately and extending from the second face:
each female clamp comprising:
a base which extends substantially transversely to the longitudinal axis;
a longitudinal portion which extends from the base substantially parallel to the longitudinal axis; and
a transverse portion which extends from the longitudinal portion substantially parallel to, and in the same direction as, the base;
so that the base, the longitudinal portion and the arm portion define a void;
each male clamp comprising:
a longitudinal portion which extends from the second face, substantially parallel to the longitudinal axis; and
a transverse portion which:
extends from the longitudinal portion substantially parallel to, and in the opposite direction from, the bases of the female clamps; and
is dimensioned to be received within the void.

11. A fastener element as claimed in claim 10, in which the base of the female clamp extends in the direction from the longitudinal axis of the fastener element towards the transverse portion of the female clamp.

12. A fastener element as claimed in claim 10, in which the base of the female clamp extends in the direction from the transverse portion of the female clamp towards the longitudinal axis of the fastener element.

13. A fastener element as claimed in claim 10, in which the base of each female clamp is a portion of the second face.

14. A fastener element as claimed in claim 10, further comprising a male clamp landing area between each female clamp and each male clamp.

15. A fastener element as claimed in claim 14, in which the each sequential male clamp, male clamp landing area, and female clamp are relatively placed in the clockwise direction when the fastener element is viewed in the direction of the longitudinal axis, looking towards the second face.

16. A fastener element as claimed in claim 14, in which each male clamp landing area further comprise a face which is adapted to limit rotational movement of a female clamp about the longitudinal axis.

17. A fastener element as claimed in claim 10, in which there are at least two male clamps and the same number of female clamps.

18. A fastener element as claimed in claim 10, in which there are two male clamps and two female clamps.

19. A fastener element as claimed in claim 10, in which the body of the fastener element, when viewed in plan view, extends in the transverse direction beyond the male clamps, male clamp landing areas, and female clamps.

20. A fastener element as claimed claim 19, in which the periphery of the body of the fastener element is circular in plan view.

21. A fastener element as claimed in claim 10, in which the first face comprises means for rotationally driving the fastener element.

22. A fastener element as claimed in claim 21, in which the means for rotationally driving the fastener element comprises a coupling for receipt of a driving tool.

23. A fastener element as claimed in claim 22, in which the coupling is one of:
a slot for the receipt of a screwdriver or the like;
a pan head; or
a hex head.

24. A fastener element as claimed in claim 22, in which the means for rotationally driving the fastener element is a manually-engageable profile.

25. A fastener element as claimed in claim 24, in which the manually-engageable profile is a thumb wheel.

26. A fastener element as claimed in claim 10, substantially as described with reference to the drawings.
